(19) United States
(12) Patent Application Publication
(10) Pub. No.: US 2025/0138230 A1
(43) Pub. Date: May 1, 2025

(54) OPTICAL FILTER AND MATCHING COMPOSITE LAYER THEREOF

(71) Applicant: PLATINUM OPTICS TECHNOLOGY INC., Taoyuan City (TW)

(72) Inventors: CHI-CHIEH WANG, Taoyuan City (TW); CHIEN-MIN HUANG, Taoyuan City (TW); REN-JIE WONG, Taoyuan City (TW); LONG-KAI YE, Taoyuan City (TW); KUANG-PING HUANG, Taoyuan City (TW)

(21) Appl. No.: 18/801,602

(22) Filed: Aug. 12, 2024

(30) Foreign Application Priority Data
Oct. 27, 2023 (TW) 112141164
May 31, 2024 (TW) 113120125

(51) Int. Cl. G02B 5/28

(52) U.S. Cl. CPC G02B 5/28

(57) ABSTRACT

An optical filter and a matching composite layer thereof are provided. The matching composite layer includes a plurality of first refraction layers, a plurality of second refraction layers, and a plurality of third refraction layers. A refractive index of the second refraction layer is greater than that of the first refraction layer, and is less than that of the third refraction layer. Any two of the second refraction layers provided with one of the first refraction layers sandwiched there-between are sandwiched between two of the third refraction layers so as to be jointly defined as a bidirectional incremental module. A number of the bidirectional incremental module included in the matching composite layer is at least M, where M is a positive integer greater than three. The M number of the bidirectional incremental modules are stacked and connected with each other.

### CROSS-REFERENCE TO RELATED PATENT APPLICATION

This application claims the benefit of priority to Taiwan Patent Application No. 112141164, filed on Oct. 27, 2023 and Taiwan Patent Application No. 113120125, filed on May 31, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a filter, and more particularly to an optical filter and a matching composite layer thereof.

### BACKGROUND OF THE DISCLOSURE

A conventional optical filter includes a plurality of refraction layers that are stacked in sequence and that have two refractive indexes having a relatively large difference therebetween. However, it is becoming more and more challenging for the configuration of the conventional optical filter to meet various different requirements.

### SUMMARY OF THE DISCLOSURE

In response to the above-referenced technical inadequacies, the present disclosure provides an optical filter and a matching composite layer thereof for effectively improving on the issues associated with conventional optical filters.

In order to solve the above-mentioned problems, one of the technical aspects adopted by the present disclosure is to provide an optical filter, which includes: a substrate, an adhesion layer formed on the substrate and having a refractive index being less than 1.42, and a matching composite layer that is formed on the adhesion layer and that includes an N number of films stacked in sequence, where N is a positive integer. The N number of the films include a plurality of first refraction layers, a plurality of second refraction layers, and a plurality of third refraction layers. Each of the first refraction layers has a first refractive index that is greater than the refractive index of the adhesion layer. Each of the second refraction layers has a second refractive index that is greater than the first refractive index. Each of the third refraction layers has a third refractive index that is greater than the second refractive index. The matching composite layer is connected to the adhesion layer through one of the third refraction layers that is defined as a first film, the matching composite layer is connected to the first film through one of the first refraction layers that is defined as a second film, and another one of the first refraction layers is arranged on one end of the matching composite layer away from the adhesion layer and is defined as an N^{th} film. In a portion of the matching composite layer between the second film and the N^{th} film, any two of the second refraction layers adjacent to each other sandwich one of the first refraction layers therebetween, and are sandwiched between two of the third refraction layers, so as to be jointly defined as a bidirectional incremental module. Moreover, a number (i.e., quantity) of the bidirectional incremental module in the matching composite layer is M, where M is a positive integer and greater than 3. The M number of the bidirectional incremental modules are connected and stacked in sequence. When the optical filter is used for incident light that has a wavelength within a range from 400 nm to 650 nm and that passes therethrough at 60 degrees relative to a normal direction thereof, the optical filter has a reflectance being less than 10%.

In order to solve the above-mentioned problems, another one of the technical aspects adopted by the present disclosure is to provide an optical filter, which includes: a substrate, an adhesion layer formed on the substrate, and a matching composite layer that is formed on the adhesion layer and that includes an N number of films stacked in sequence, where N is a positive integer. The N number of the films include a plurality of first refraction layers, a plurality of second refraction layers, and a plurality of third refraction layers. Each of the first refraction layers has a first refractive index that is greater than a refractive index of the adhesion layer. Each of the second refraction layers has a second refractive index that is greater than the first refractive index. Each of the third refraction layers has a third refractive index that is greater than the second refractive index. The matching composite layer is connected to the adhesion layer through one of the third refraction layers that is defined as a first film, the matching composite layer is connected to the first film through one of the first refraction layers that is defined as a second film, and one of the films is arranged on one end of the matching composite layer away from the adhesion layer and is defined as an N^{th} film. In a portion of the matching composite layer between the second film and the Nth film, any two of the second refraction layers adjacent to each other sandwich one of the first refraction layers therebetween, and are sandwiched between two of the third refraction layers, so as to be jointly defined as a bidirectional incremental module. Moreover, a number of the bidirectional incremental module in the matching composite layer is M, where M is a positive integer and greater than 3. The M number of the bidirectional incremental modules are connected and stacked in sequence.

In order to solve the above-mentioned problems, yet another one of the technical aspects adopted by the present disclosure is to provide a matching composite layer of an optical filter, which includes N number of films stacked in sequence, where N is a positive integer. The N number of the films include a plurality of first refraction layers, a plurality of second refraction layers, and a plurality of third refraction layers. Each of the first refraction layers has a first refractive index. Each of the second refraction layers has a second refractive index that is greater than the first refractive index. Each of the third refraction layers has a third refractive index that is greater than the second refractive index. One of the third refraction layers is arranged on one end of the matching composite layer and is defined as a first film, the matching composite layer is connected to the first film through one of the first refraction layers that is defined as a second film, and one of the films is arranged on another end of the matching composite layer and is defined as an N^{th} film. In a portion of the matching composite layer between the second film and the N^{th} film, any two of the second refraction layers adjacent to each other sandwich one of the first refraction layers therebetween, and are sandwiched between two of the third refraction layers, so as to be jointly defined as a bidirectional incremental module. Moreover, a number of the bidirectional incremental module in the matching composite layer is M, where M is a positive integer and greater than 3. The M number of the bidirectional incremental modules are connected and stacked in sequence.

Therefore, the optical filter in the present disclosure is provided with the M number of the bidirectional incremental modules that are connected and stacked in sequence and that have not been published in the relevant art, and the refractive index of each of the bidirectional incremental modules can be gradually increased from the corresponding first refraction layer in two opposite directions, thereby adjusting a distribution of the refractive index of the matching composite layer for enabling a design of the optical filter to meet various different requirements.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic planar view of an optical filter according to an embodiment of the present disclosure;

FIG. 2 is a table showing a configuration of the optical filter of FIG. 1; and

FIG. 3 is a simulation diagram showing the optical filter of FIG. 2 being simulated at different angles.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

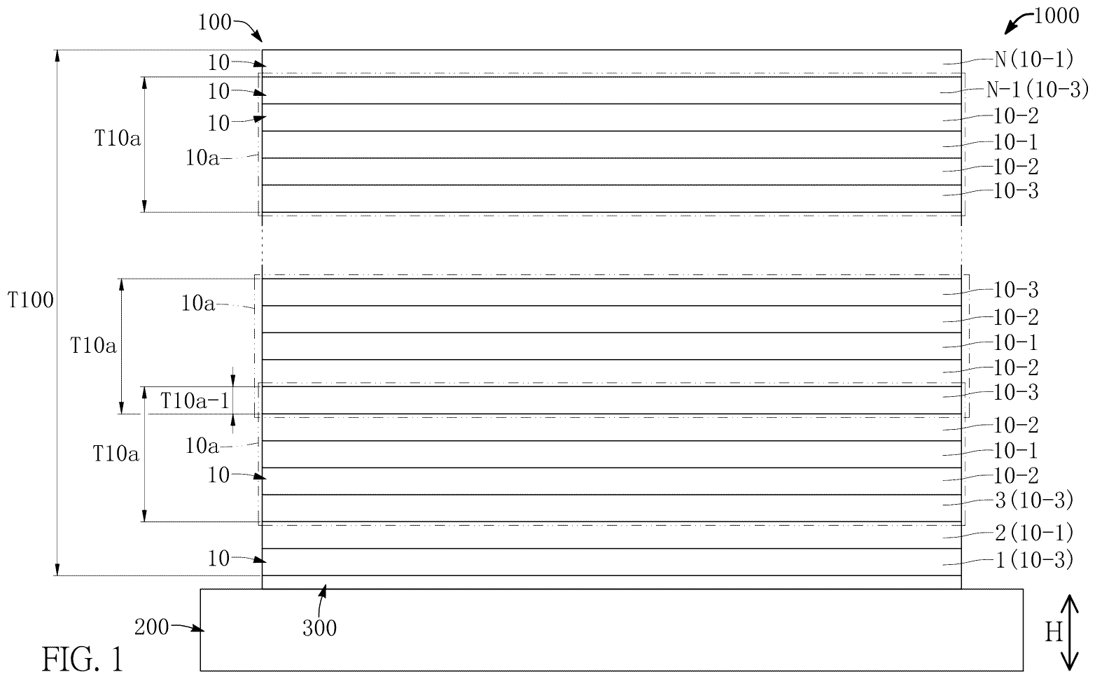

Referring to FIG. 1 to FIG. 3, an embodiment of the present disclosure is provided. The present embodiment provides an optical filter 1000 that is preferably a flat sheet structure. The optical filter 1000 in the present embodiment can be applied to visible light (i.e., light having a wavelength of 420 nm to 720 nm).

In the present embodiment, the optical filter 1000 includes a substrate 200, an adhesion layer 300 formed on the substrate 200, and a matching composite layer 100 that is formed on the adhesion layer 300. The substrate 200 can be a glass substrate (e.g., a blue glass or an IR cut glass), and the matching composite layer 100 is connected to the substrate 200 through the adhesion layer 300, but the present disclosure is not limited thereto. For example, in other embodiments of the present disclosure not shown in the drawings, the matching composite layer 100 can be in cooperation with other components.

Specifically, the matching composite layer 100 includes an N number of films 10 stacked in sequence. The N number of the films 10 are preferably stacked along a thickness direction H thereof, and lateral edges of the N number of the films 10 are flush with each other and are preferably flush with a lateral edge of the adhesion layer 300. Moreover, N is a positive integer (e.g., N can be within a range from 30 to 80), and N is provided as 44 in the present embodiment (e.g., the films 10 and the adhesion layer 300 in the present embodiment are 45 layers in total), but the present disclosure is not limited thereto.

Furthermore, the N number of the films 10 can be divided into a plurality of first refraction layers 10-1, a plurality of second refraction layers 10-2, and a plurality of third refraction layers 10-3 according to refractive indexes thereof. Each of the first refraction layers 10-1 has a first refractive index that is greater than a refractive index of the adhesion layer 300. Each of the second refraction layers 10-2 has a second refractive index that is greater than the first refractive index. Each of the third refraction layers 10-3 has a third refractive index that is greater than the second refractive index.

In addition, in order to clearly describe a configuration of the matching composite layer 100, the films 10 can be renamed (or redefined) according to the stacked sequence thereof. In other words, the matching composite layer 100 is connected to the adhesion layer 300 through one of the third refraction layers 10-3 that is defined as a first film 1, the matching composite layer 100 is connected to the first film 1 through one of the first refraction layers 10-1 that is defined as a second film 2, and one of the films 10 is arranged on one end of the matching composite layer 100 away from the adhesion layer 300 and is defined as an N^{th} film N. Specifically, the N^{th} film N in the present embodiment is the first refraction layer 10-1, but the N^{th} film N can be made of other materials (e.g., the second refraction layer 10-2 or the third refraction layer 10-3) according to practical requirements in other embodiments of the present disclosure not shown in the drawings.

In the present embodiment, the refractive index of the adhesion layer 300 is less than 1.42 (e.g., the refractive index of the adhesion layer 300 being within a range from 1.35 to 1.42), the first refractive index can be within a range from 1.35 to 1.58, the second refractive index can be within a range from 1.62 to 1.93, and the third refractive index can be within a range from 2.0 to 2.8. In other words, the optical filter 1000 in the present embodiment is formed by stacking four kinds of optical films that have different refractive indexes, thereby providing various optical configurations and structures.

It should be noted that any one of the adhesion layer 300, the first refraction layer 10-1, the second refraction layer 10-2, and the third refraction layer 10-3 in the following description is described by a possible material, but the present disclosure is not limited thereto. For example, the adhesion layer 300 can be a magnesium fluoride (MgF₂) layer, the first refraction layer 10-1 can be a silicon dioxide (SiO₂) layer, the second refraction layer 10-2 can be an alumina (Al₂O₃) layer, and the third refraction layer 10-3 can be a titanium dioxide (TiO₂) layer. For example, in other embodiments of the present disclosure not shown in the drawings, the adhesion layer 300 is not limited to being made of a material of a refractive index that is less than 1.42, and can be made of other materials (e.g., one of the first refraction layer 10-1, the second refraction layer 10-2, and the third refraction layer 10-3) according to practical requirements. In other words, the first refractive index can be less than or equal to the refractive index of the adhesion layer 300.

Specifically, in a portion of the matching composite layer 100 (sandwiched) between the second film 2 and the N^{th} film N, any two of the second refraction layers 10-2 adjacent to each other sandwich one of the first refraction layers 10-1 therebetween, and are sandwiched between two of the third refraction layers 10-3, so as to be jointly defined as a bidirectional incremental module 10a.

Moreover, a number of the bidirectional incremental module 10a in the matching composite layer 100 is M. In the present embodiment, the M number of the bidirectional incremental modules 10a are connected and stacked in sequence, and the M number of the bidirectional incremental modules 10a belong to the portion of the matching composite layer 100 from the third film 3 to an N−1^{th} film N−1. Furthermore, M is a positive integer and is greater than 3, and M of the present embodiment is 10, but the present disclosure is not limited thereto. In other words, while M of the present embodiment is greater than N/5, M can be greater than N/4 in other embodiments of the present disclosure not shown in the drawings.

Accordingly, in any one of the bidirectional incremental modules 10a, any one of the two second refraction layers 10-2 is sandwiched between the first refraction layer 10-1 and one of the two third refraction layers 10-3, so that a refractive index of the bidirectional incremental module 10a can be gradually increased from the first refraction layer 10-1 toward any one of the two third refraction layers 10-3.

In summary, the optical filter 1000 in the present embodiment is provided with the M number of the bidirectional incremental modules 10a that are connected and stacked in sequence and that have not been published in the relevant art, and the refractive index of each of the bidirectional incremental modules 10a can be gradually increased from the corresponding first refraction layer 10-1 in two opposite directions, thereby adjusting a distribution of refractive index of the matching composite layer 100 for enabling a design of the optical filter 1000 to meet various different requirements.

It should be noted that, when light (e.g., the light of wavelength being within a range from 400 nm to 720 nm) enters into the optical filter 1000 of the present embodiment by an angle that is changed relative to a vertical direction from 30 degrees to 60 degrees, the matching composite layer 100 preferably has at least part of the following features for enabling the optical filter 1000 to have a low reflectance, but the present disclosure is not limited thereto.

In the present embodiment, each of the M number of the bidirectional incremental modules 10a has a module thickness T10a that is preferably within a range from 320 nm to 380 nm. Specifically, the module thicknesses T10a of the M number of the bidirectional incremental modules 10a provided by the present embodiment are different from each other (e.g., 376.49 mm, 364.05 mm, 372.95 mm, 354.67 mm, 332.94 mm, 324.5 mm, 325.44 mm, 326.12 mm, 325.09 mm, and 336.59 mm). In other words, the module thicknesses T10a of any two of the M number of the bidirectional incremental modules 10a adjacent to each other can be adjusted to be the same or to be different from each other according to practical requirements, and the present disclosure is not limited thereto.

Moreover, in order to precisely control the optical filter 1000 having a predetermined thickness to provide a better optical performance, any two of the M number of the bidirectional incremental modules 10a adjacent to each other in the present embodiment share one of the third refraction layers 10-3 that has a common thickness T10a-1. Specifically, a sum of the module thicknesses T10a of the M number of the bidirectional incremental modules 10a is greater than a total thickness T100 of the matching composite layer 100. Furthermore, a sum of the common thicknesses T10a-1 of the M number of the bidirectional incremental modules 10a is within a range from 20% to 25% of the sum of the module thicknesses T10a of the M number of the bidirectional incremental modules 10a, thereby effectively controlling the total thickness T100 of the matching composite layer 100. In the present embodiment, the sum of the module thicknesses T10a of the M number of the bidirectional incremental modules 10a is within a range from 105% to 140% of the total thickness T100 of the matching composite layer 100, but the present disclosure is not limited thereto.

In order to enable each of the bidirectional incremental modules 10a to provide a better optical performance through the refractive index thereof that is gradually increased in two opposite directions, each of the bidirectional incremental modules 10a preferably has at least part of the following features, but the present disclosure is not limited thereto.

Specifically, in each of the M number of the bidirectional incremental modules 10a, a thickness of each of the two second refraction layers 10-2 is less than a thickness of the first refraction layer 10-1 and is less than a thickness of any one of the two third refraction layers 10-3, a difference between the thicknesses of the two second refraction layers 10-2 is less than 10 nm, and a difference between the thicknesses of the two third refraction layers 10-3 is less than 15 nm. Furthermore, in the M number of the bidirectional incremental modules 10a, a maximum thickness and a minimum thickness of the first refraction layers 10-1 have a difference therebetween that is less than or equal to 15 nm.

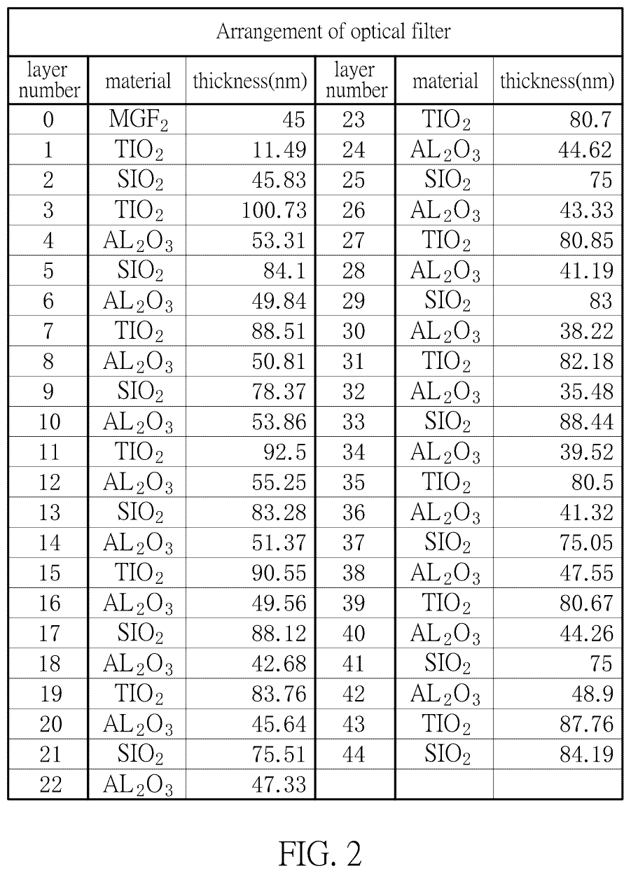

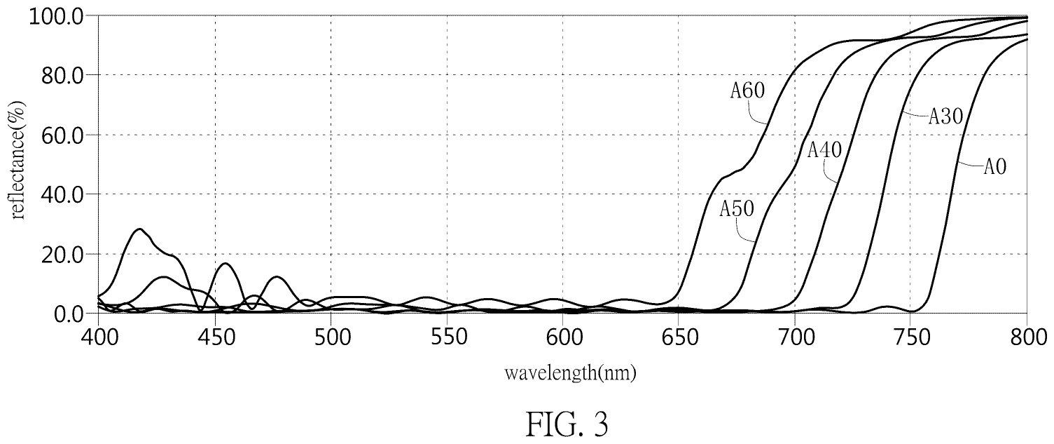

Specifically, the adhesion layer 300 and the matching composite layer 100 of the optical filter 1000 in the present embodiment are provided in a configuration as shown in FIG. 2, and simulation results from experimentation is provided in a table as shown in FIG. 3 after a simulation experiment.

Accordingly, as shown in a curved line A30 of FIG. 3, when the optical filter 1000 is used for incident light that has a wavelength within a range from 400 nm to 720 nm and that passes therethrough at 30 degrees relative to a normal direction thereof, the optical filter 1000 has a reflectance being less than 1% (e.g., the reflectance being about 0.69%). As shown in a curved line A40 of FIG. 3, when the optical filter 1000 is used for incident light that has a wavelength within a range from 400 nm to 720 nm and that passes therethrough at 40 degrees relative to the normal direction thereof, the optical filter 1000 has a reflectance being less than or equal to 1.5% (e.g., the reflectance being about 1.1%). Moreover, as shown in a curved line A60 of FIG. 3, when the optical filter 1000 is used for incident light that has a wavelength within a range from 400 nm to 650 nm and that passes therethrough at 60 degrees relative to the normal direction thereof, the optical filter 1000 has a reflectance being less than 10% (e.g., the reflectance being about 7.2%). In addition, a curved line A0 of FIG. 3 shows a reflectance of the optical filter 1000 with respect to incident light that passes through the optical filter 1000 along the normal direction.

### Beneficial Effects of the Embodiment

In conclusion, the optical filter in the present disclosure is provided with the M number of the bidirectional incremental modules that are connected and stacked in sequence and that have not been published in the relevant art, and the refractive index of each of the bidirectional incremental modules can be gradually increased from the corresponding first refraction layer in two opposite directions, thereby adjusting a distribution of refractive index of the matching composite layer for enabling a design of the optical filter to meet various different requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical filter, comprising:
a substrate;
an adhesion layer formed on the substrate and having a refractive index being less than 1.42; and
a matching composite layer formed on the adhesion layer and including an N number of films stacked in sequence, wherein N is a positive integer, and the N number of the films include:
a plurality of first refraction layers each having a first refractive index that is greater than the refractive index of the adhesion layer;
a plurality of second refraction layers each having a second refractive index that is greater than the first refractive index; and
a plurality of third refraction layers each having a third refractive index that is greater than the second refractive index;
wherein the matching composite layer is connected to the adhesion layer through one of the third refraction layers that is defined as a first film, the matching composite layer is connected to the first film through one of the first refraction layers that is defined as a second film, and another one of the first refraction layers is arranged on one end of the matching composite layer away from the adhesion layer and is defined as an N^{th} film;
wherein, in a portion of the matching composite layer between the second film and the N^{th} film, any two of the second refraction layers adjacent to each other sandwich one of the first refraction layers therebetween, and are sandwiched between two of the third refraction layers, so as to be jointly defined as a bidirectional incremental module;
wherein a number of the bidirectional incremental module in the matching composite layer is M, where M is a positive integer greater than 3, the M number of the bidirectional incremental modules being connected and stacked in sequence;
wherein, when the optical filter is used for incident light that has a wavelength within a range from 400 nm to 650 nm and that passes therethrough at 60 degrees relative to a normal direction thereof, the optical filter has a reflectance being less than 10%.

2. The optical filter according to claim 1, wherein any two of the M number of the bidirectional incremental modules adjacent to each other share one of the third refraction layers, and N is within a range from 30 to 80.

3. The optical filter according to claim 1, wherein any two of the M number of the bidirectional incremental modules adjacent to each other share one of the third refraction layers, each of the M number of the bidirectional incremental modules has a module thickness, and a sum of the module thicknesses of the M number of the bidirectional incremental modules is greater than a total thickness of the matching composite layer.

4. The optical filter according to claim 1, wherein any two of the M number of the bidirectional incremental modules adjacent to each other share one of the third refraction layers, each of the M number of the bidirectional incremental modules has a module thickness, and a sum of the module thicknesses of the M number of the bidirectional incremental modules is within a range from 105% to 140% of a total thickness of the matching composite layer.

5. The optical filter according to claim 1, wherein any two of the M number of the bidirectional incremental modules adjacent to each other share one of the third refraction layers that has a common thickness, and each of the M number of the bidirectional incremental modules has a module thickness, and wherein a sum of the common thicknesses of the M number of the bidirectional incremental modules is within a range from 20% to 25% of a sum of the module thicknesses of the M number of the bidirectional incremental modules.

6. The optical filter according to claim 3, wherein the module thickness of each of the M number of the bidirectional incremental modules is within a range from 320 nm to 380 nm.

7. The optical filter according to claim 1, wherein, in each of each of the M number of the bidirectional incremental modules, a thickness of each of the two second refraction layers is less than a thickness of the first refraction layer and is less than a thickness of any one of the two third refraction layers.

8. The optical filter according to claim 1, wherein, in the M number of the bidirectional incremental modules, a maximum thickness and a minimum thickness of the first refraction layers have a difference therebetween that is less than or equal to 15 nm.

9. The optical filter according to claim 1, wherein, in each of the M number of the bidirectional incremental modules, a difference between thicknesses of the two second refraction layers is less than 10 nm.

10. The optical filter according to claim 1, wherein, in each of the M number of the bidirectional incremental modules, a difference between thicknesses of the two third refraction layers is less than 15 nm.

11. The optical filter according to claim 1, wherein the refractive index of the adhesion layer is within a range from 1.35 to 1.42, the first refractive index is within a range from 1.35 to 1.58, the second refractive index is within a range from 1.62 to 1.93, and the third refractive index is within a range from 2.0 to 2.8.

12. An optical filter, comprising:
a substrate;
an adhesion layer formed on the substrate; and
a matching composite layer formed on the adhesion layer and including an N number of films stacked in sequence, wherein N is a positive integer, and the N number of the films include:
a plurality of first refraction layers each having a first refractive index that is greater than a refractive index of the adhesion layer;
a plurality of second refraction layers each having a second refractive index that is greater than the first refractive index; and
a plurality of third refraction layers each having a third refractive index that is greater than the second refractive index;
wherein the matching composite layer is connected to the adhesion layer through one of the third refraction layers that is defined as a first film, the matching composite layer is connected to the first film through one of the first refraction layers that is defined as a second film, and one of the films is arranged on one end of the matching composite layer away from the adhesion layer and is defined as an N^{th} film;
wherein, in a portion of the matching composite layer between the second film and the N^{th} film, any two of the second refraction layers adjacent to each other sandwich one of the first refraction layers therebetween, and are sandwiched between two of the third refraction layers, so as to be jointly defined as a bidirectional incremental module;
wherein a number of the bidirectional incremental module in the matching composite layer is M, where M is a positive integer and greater than 3, the M number of the bidirectional incremental modules being connected and stacked in sequence.

13. The optical filter according to claim 12, wherein any two of the M number of the bidirectional incremental modules adjacent to each other share one of the third refraction layers, and N is within a range from 30 to 80.

14. The optical filter according to claim 12, wherein any two of the M number of the bidirectional incremental modules adjacent to each other share one of the third refraction layers, each of the M number of the bidirectional incremental modules has a module thickness, and a sum of the module thicknesses of the M number of the bidirectional incremental modules is greater than a total thickness of the matching composite layer.

15. The optical filter according to claim 12, wherein, in each of each of the M number of the bidirectional incremental modules, a thickness of each of the two second refraction layers is less than a thickness of the first refraction layer and is less than a thickness of any one of the two third refraction layers, a difference between the thicknesses of the two second refraction layers is less than 10 nm, and a difference between the thicknesses of the two third refraction layers is less than 15 nm.

16. The optical filter according to claim 15, wherein, in the M number of the bidirectional incremental modules, a maximum thickness and a minimum thickness of the first refraction layers have a difference therebetween that is less than or equal to 15 nm.

17. A matching composite layer of an optical filter, comprising:
N number of films stacked in sequence, wherein N is a positive integer, and the N number of the films include:
a plurality of first refraction layers each having a first refractive index;
a plurality of second refraction layers each having a second refractive index that is greater than the first refractive index; and
a plurality of third refraction layers each having a third refractive index that is greater than the second refractive index;
wherein one of the third refraction layers is arranged on one end of the matching composite layer and is defined as a first film, the matching composite layer is connected to the first film through one of the first refraction layers that is defined as a second film, and one of the films is arranged on another end of the matching composite layer is defined as an N^{th} film;
wherein, in a portion of the matching composite layer between the second film and the N^{th} film, any two of the second refraction layers adjacent to each other sandwich one of the first refraction layers therebetween, and are sandwiched between two of the third refraction layers, so as to be jointly defined as a bidirectional incremental module;
wherein a number of the bidirectional incremental module in the matching composite layer is M, where M is a positive integer and greater than 3, the M number of the bidirectional incremental modules being connected and stacked in sequence.

18. The matching composite layer according to claim 17, wherein any two of the M number of the bidirectional incremental modules adjacent to each other share one of the third refraction layers, and N is within a range from 30 to 80.

19. The matching composite layer according to claim 17, wherein any two of the M number of the bidirectional incremental modules adjacent to each other share one of the third refraction layers that has a common thickness, and each of the M number of the bidirectional incremental modules has a module thickness, and wherein a sum of the common thicknesses of the M number of the bidirectional incremental modules is within a range from 20% to 25% of a sum of the module thicknesses of the M number of the bidirectional incremental modules.

20. The matching composite layer according to claim 17, wherein any two of the M number of the bidirectional incremental modules adjacent to each other share one of the third refraction layers, each of the M number of the bidirectional incremental modules has a module thickness being within a range from 320 nm to 380 nm, and a sum of the module thicknesses of the M number of the bidirectional incremental modules is within a range from 105% to 140% of a total thickness of the matching composite layer.
